(19) United States
(12) Patent Application Publication
(10) Pub. No.: US 2014/0117922 A1
(43) Pub. Date: May 1, 2014

(54) PORTABLE DC POWER TOOL BATTERY ADAPTER AND CHARGER WITH USB INTERFACE

(71) Applicant: Lam Pham, San Diego, CA (US)

(72) Inventor: Lam Pham, San Diego, CA (US)

(21) Appl. No.: 14/064,677

(22) Filed: Oct. 28, 2013

Related U.S. Application Data
(60) Provisional application No. 61/721,009, filed on Oct. 31, 2012.

(51) Int. Cl. H02J 7/00

(52) U.S. Cl. CPC H02J 7/0054
USPC 320/103

(57) ABSTRACT

A portable power tool adapter device used to power and charge an electronic device. The power tool adapter device may include an adapter housing with mechanical fittings configured to mate with various power tool battery types, a charger board circuit for controlling various functions of the adapter device, a DC-to-DC step down converter and regulator for converting the high voltage from the power tool to a low voltage, specialized battery input connectors for electrically connecting the battery to the charger board circuit, heat vents for dissipating heat generated by the charger board circuit, a regulator feedback circuit for maintaining output voltages at desired levels, and a multi-pin input/output connector for charging the power tool battery and supplying multiple output voltages when connected to an external connector module.

### RELATED APPLICATIONS

This application claims the benefit of priority of U.S. Provisional Application Ser. No. 61/721,009 filed Oct. 31, 2012, which is hereby incorporated by reference in its entirety.

### BACKGROUND

This document generally relates to electronic devices, and more specifically, to DC power adapter devices.

Portable battery backup chargers provide a quick and convenient way to recharge and provide immediate power to electronic devices on the go. Such battery backup chargers are often designed for the sole purpose of recharging and powering low voltage electronic devices such as smart phones, tablets, and other electronics devices meeting the necessary voltage requirements. In a conventional portable battery backup charger, specialized large capacity batteries are often used due to its ability to fully recharge low voltage electronic devices multiple times before being fully depleted. However, these specialized batteries are expensive and often take many hours for a full recharge.

A DC power adapter may be used to convert a 12 volt power supply, such as from a car battery, to a voltage that is compatible with low voltage electronic devices. However, these DC power adapters are not designed to be portable with the battery and limited to use in an automobile, water craft, or other similar vehicles having a 12 volt battery power supply.

Therefore it would be desirable to be able to provide improved and cost effective battery power adapters for portable electronic devices.

### SUMMARY

It is an advantage of the present invention to provide a portable adapter and charger apparatus adapted to be interchangeable with various power tool battery types. For example, a user can quickly swap in a new battery and continue to use the charger without having to wait for the charger's battery to fully recharge.

It is another advantage of the present invention to provide a portable adapter and charger apparatus that includes a DC to DC down converter to convert DC power from a 14 v to 48 v power tool battery to a 3 v to 28 v DC power source that is compatible to recharge mobile personal electronic devices such as a phone, tablet, camera, radio, music player, video player, GPS navigator.

It is yet another advantage of the present invention to provide a portable adapter and charger apparatus that produces a low voltage DC output voltage of 3V to 28V and current of 3 Amps or greater to power and quickly recharge one or more personal electronic devices.

It is no less another advantage of the present invention to provide a portable adapter and charger apparatus that includes a battery capacity LED meter for providing status information to the user of the remaining battery capacity.

An additional advantage of the present invention provides a portable adapter and charger apparatus that includes a multi-port connector for charging multiple portable electronic devices in parallel for a quick recharge.

These and other objects, features and advantages of the present invention will become more apparent in light of the following detailed description of preferred embodiments thereof, as illustrated in the accompanying drawings.

### BRIEF DESCRIPTION OF THE DRAWINGS

The present invention will be more clearly understood from the following detailed description of the preferred embodiments of the invention and from the attached drawings, in which:

FIG. 1 illustrates a compact power tool adapter and charger for converting a high voltage power supply from a power tool battery source to a mobile electronics device, in accordance with an embodiment of the present invention;

FIG. 2 illustrates a block diagram of electrical components of a power tool adapter and charger for powering and/or charging electronic devices, in accordance with an embodiment of the present invention;

FIG. 3 illustrates a block diagram of an adapter housing of the power tool adapter and charger depicted in FIG. 2, in accordance with an embodiment of the present invention;

FIG. 4 illustrates a block diagram of a charger circuit board of the power tool adapter and charger depicted in FIG. 2, in accordance with an embodiment of the present invention, in accordance with an embodiment of the present invention;

FIG. 5 illustrates a block diagram of a power tool battery with an integrated charger and USB ports, in accordance with an embodiment of the present invention;

FIG. 6 illustrates a block diagram of a charger circuit board of the power tool battery with integrated charger and USB ports depicted in FIG. 5, in accordance with an embodiment of the present invention;

FIG. 7 illustrates a perspective view of interfacing components of a power tool rechargeable system, in accordance with an embodiment of the present invention;

FIG. 8 illustrates a perspective view of interfacing components of the power tool rechargeable system of FIG. 7 revealing a battery plate, in accordance with an embodiment of the present invention;

FIG. 9 illustrates features of the battery plate depicted in FIG. 8, in accordance with an embodiment of the present invention;

FIG. 10 illustrates components of a front panel of the power tool adapter and charger device depicted in FIG. 7, in accordance with an embodiment of the present invention;

FIG. 11 illustrates components of a rear panel of the power tool adapter and charger device depicted in FIG. 7, in accordance with an embodiment of the present invention;

FIG. 12 illustrates a perspective view of a tower battery configuration connected to a power tool adapter and charger device, in accordance with an embodiment of the present invention;

FIG. 13 illustrates a mobile phone vertically oriented and coupled to the tower battery configuration and power tool adapter and charger device of FIG. 12, in accordance with an embodiment of the present invention;

FIG. 14 illustrates a cradle fixture coupling a mobile phone to a power tool adapter and charger device, in accordance with an embodiment of the present invention;

FIG. 15 illustrates components of a front panel of a power tool adapter and charger device with multiple USB ports, in accordance with an embodiment of the present invention;

FIG. 16 illustrates a top perspective view of a circuit board of a power tool adapter and charger device with multiple USB ports, in accordance with an embodiment of the present invention;

FIG. 17 illustrates a bottom perspective view of the circuit board of FIG. 16, in accordance with an embodiment of the present invention.

In the attached figures, multiple figures may have the same reference numeral indicating similar components and/or features.

### DETAILED DESCRIPTION

Prior to the invention is described in detail, unless otherwise indicated, it is to be understood that this invention is not limited to any particular materials, size, or the like, as such may vary. Terminology used herein is for the purposes of describing particular embodiments only, and is not intended to be limiting.

High voltage rechargeable batteries are often used in power tool applications such as a portable power drill, an impact driver, and a saw due to its high charge capacity, high voltage and relatively quick recharging capabilities. The voltage requirements to operate these power tools may range between 14 to 48 volts. As defined in this specification, a High Voltage Power Tool Rechargeable Battery (HVPT Rechargeable Battery) is any power tool rechargeable battery having a voltage range between 14 to 48 volts. The HVPT rechargeable battery may be comprised of active material including but not limited to lead-acid, alkaline, nickel-iron, nickel-cadmium, lithium-ion, and sodium-ion.

Although HVPT rechargeable batteries may offer many advantages to the power tool industry, it may also be used as a portable battery backup power source in other unintended applications such as mobile phones, Bluetooth, tablets, laptops, GPS devices, portable radios, watches, music players, speakers, cameras and other electronic devices. Thus, repurposing or expanding HVPT rechargeable batteries for other use beyond power tool applications may offer considerable cost savings and convenience to power tool owners. For example, rather than purchasing a dedicated pack of rechargeable batteries to recharge a mobile phone, tablet or portable computer, power tool owners have at their disposal a HVPT rechargeable battery that can be configured, via a power adapter-charger, to recharge these electronic devices when no other power source is available. Unfortunately, there is no such power adapter device in the consumer market that is currently available to power tool owners.

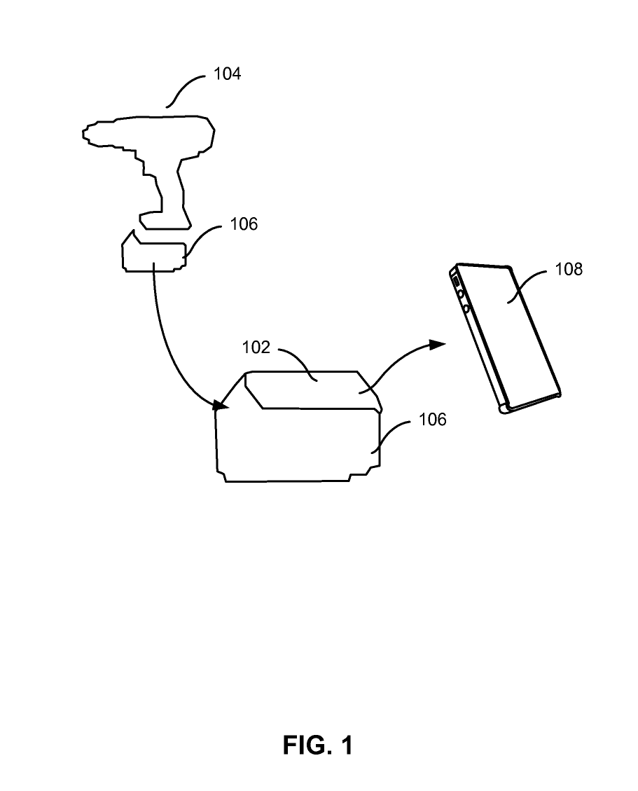

FIG. 1 illustrates a compact power tool adapter and charger 102 for converting a high voltage power supply from a battery source to a mobile electronics device, in accordance with an embodiment of the present invention. In FIG. 1, the compact power tool adapter and charger 102 is adapted to fit and mate with a power tool HVPT Rechargeable Battery 106 of a power tool 104, and supply the necessary power to recharge a mobile device 108. The power tool HVPT Rechargeable Battery 106 is a portable interchangeable battery and carries a high voltage of 14 to 48 volt. In this embodiment, the power tool adapter and charger 102 may be comprised of a housing that is configured to mate with the HVPT Rechargeable Battery 106. The housing of the power tool adapter and charger 102 may be designed to have a locking/unlocking mechanism similar to that of the power tool 104 such that the power tool adapter and charger 102 may be secured/detached to the power tool HVPT Rechargeable Battery 106. Because the power tool HVPT Rechargeable Battery 106 is designed to be an interchangeable battery, a user can quickly swap in a new battery and continue to use the power tool adapter and charger 102 without having to wait for the charger's battery to fully recharge. Power from the HVPT Rechargeable Battery 106 is delivered to the power tool adapter and charger 102 where it is then converted to provide a rechargeable power supply to the mobile device 108 via a USB cable (not shown). Further illustrations presenting the physical connections and specific components of the power tool adapter and charger 102 are provided herein below.

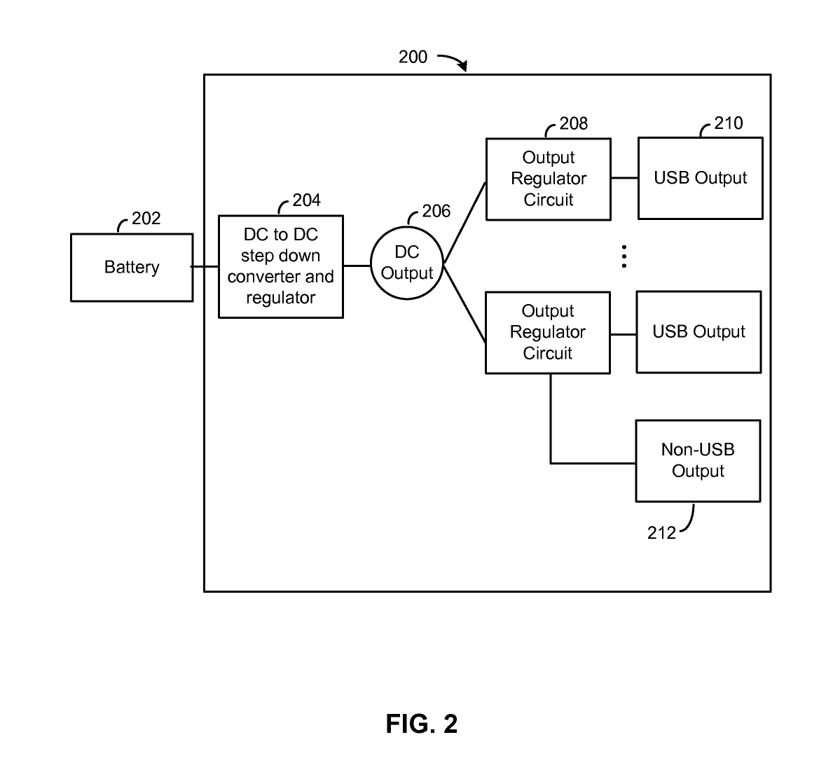

FIG. 2 illustrates a block diagram of general electrical components of the power tool adapter and charger 200 device presented in FIG. 1, in accordance with an embodiment of the present invention. An HVPT rechargeable battery 202 having a supply voltage of 14V-48V is provided at an input side of a DC-to-DC step down converter and regulator 204 of the power tool adapter and charger 200, where the supply voltage is then converted from the high DC voltage (14-48V) to a DC output voltage of 3-28V and a current of 3 Amps or greater, for example. Depending on the amount of power drawn from the output power side, excess heat may be generated by the DC-DC step down circuit 204. Various heat dissipation techniques are presented later in this document as to improve the reliability and prevent premature failure of the DC-DC step down circuit 204.

A cable and cable interconnects (not shown) of proper wire gauge is used to electrically connect the battery 202 to the power tool adapter and charger 200. Next, the input voltage from the DC-to-DC step down converter and regulator 204 is transformed to a DC Output 206 having voltage of 3V-28V. The DC Output 206 voltages are fed as inputs to multiple USB Outputs 210 through corresponding output regulator circuits 208, providing a standardized connection for supplying a 3-5V power output to low voltage electronic devices. Optionally, other power output configurations may include DC power outputs (i.e., Non-USB) 212 designs such as an n-pin connector, mini-DIN, lugs, sockets, pins and tabs, for supplying voltages such as 5V-28V.

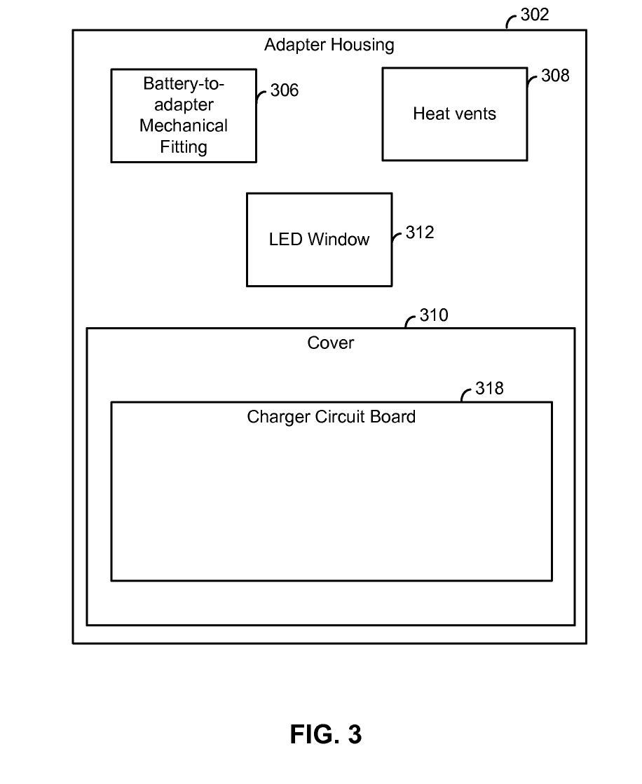

FIG. 3 illustrates a block diagram of general mechanical and electrical components of an adapter housing 302 of the power tool adapter and charger depicted in FIG. 2. Although not shown, the adapter housing 302 may have various configurations making it compatible for different HVPT rechargeable batteries as defined by various vendors and manufacturers. In one embodiment, the adapter housing 302 may also include a battery-to-adapter mechanical fitting 306 to physically mate with the battery. Examples of some mechanical fittings include but are not limited to snap on fittings, internal or external fasteners, and form fitting components. In this embodiment, the mechanical fitting 306 of the adapter housing 302 is designed to bind together with the battery to form a single unit, resulting in a single portable charger and battery device. In practice, the adapter housing 302 can be easily attached and removed from the battery, making it a convenient to replace batteries if two or more back up batteries are available.

Heat vents 308 are also included in the adapter housing 302 to handle and prevent the housing and associated components from overheating due to the excess heat generated by the electrical components. Because of its compact design, the adapter housing 302 may incorporate a fanless method (i.e., via heat vents, ventilation holes, etc.) to properly ventilate and release internal heat from the adapter housing 302. The adapter housing 302 may be constructed from materials such as metal, plastic, or other lightweight durable material to protect the internal components from external elements such as liquid and dust while still dissipating the heat to the external environment.

In addition to heat vents, other cooling systems may be employed to the adapter housing 302 such as compact fans, heat sinks, or other portable cooling device.

An LED window 312 in the adapter housing 302 provides an opening for battery status and charge information presented and discussed later in this document. The adapter housing 302 may also include an internal cover 310 to protect a charger circuit board 318 from possible shorting or external tampering. The internal cover 310 may be constructed from metal, plastic, or other lightweight durable material for additional protection and conduction of heat dissipation of the charger circuit board 318. In this example, the charger circuit board 318 is responsible for converting and regulating power in the power tool adapter and charger. Further details of the charger circuit board 318 are provided herein below.

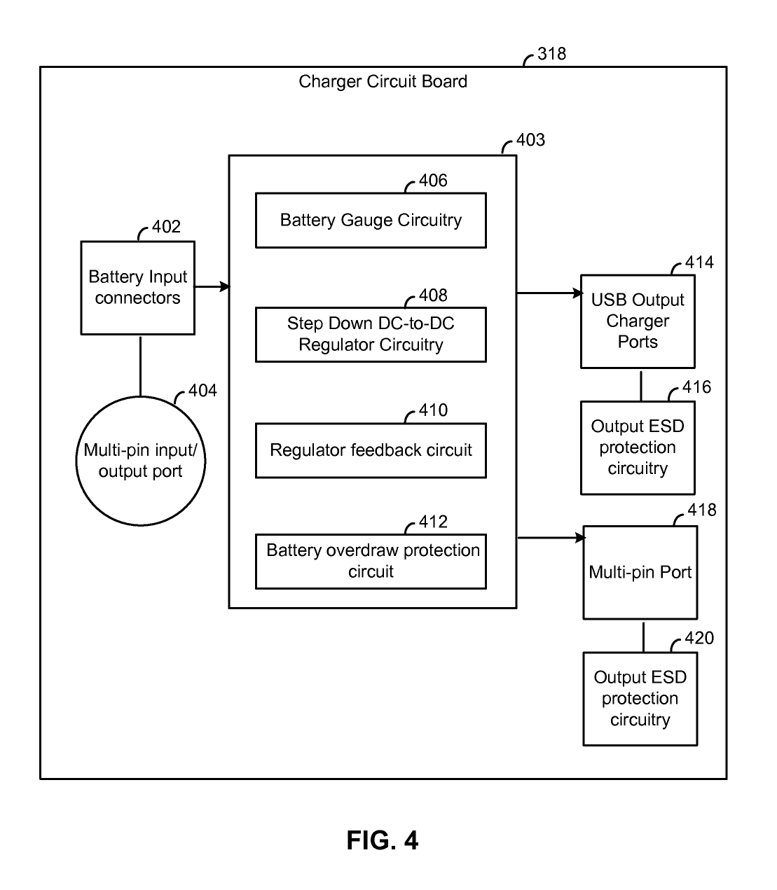

FIG. 4 illustrates a block diagram of mechanical and electrical components of the charger circuit board 318 of the power tool adapter and charger depicted in FIG. 2. Power from a rechargeable battery source 202 is supplied at battery input connectors 402 of the charge circuit board 318. A multi-pin input/output connector port 404 is mounted on the charge circuit board 318 to receive multiple voltage inputs from various rechargeable battery configurations. Battery configurations may include but is not limited to flat batteries and tower batteries. The multi-pin input/output connector port 404 may include but is not limited to a slide-in connector, a pin or socket interconnects, or any other specialized keyed connectors. Keyed connectors have the advantage of ensuring correct polarity connections between cable connectors.

A charge and adapter circuitry 403 disposed on the charge circuit board 318 includes a battery gauge circuit 406, a step down DC-to-DC converter/regulator circuit 408, a regulator feedback circuit 410 and a battery protection circuit 412. Materials forming the charge circuit board 318 may include rigid or flexible printed circuit boards (PCBs) made from laminate materials such as FR-2, FR-4, Polyimide, or Teflon for example.

The battery gauge circuit 406 may include a battery capacity LED meter and switches (not shown) for displaying and providing battery capacity information, error information, or battery activity information.

The step down DC-to-DC converter/regulator circuit 408 is responsible for converting and regulating the power supplied by the high DC voltage (14-48V) 202 to a DC output voltage of 3V to 28V having a current of 3 Amps or greater.

The regulator feedback circuit 410 controls and maintains the output voltage at a constant voltage level (e.g., between 3V to 28V).

The battery overdraw protection circuitry 412 is included to prevent damage to charge circuit board 318, battery, and other electrical components by limit output current to less than 15 Amps in the event of a short-circuit, overdraw, or improper input voltage. A reduced regulated voltage of 3-5V is supplied at an output side of the charge circuit board 318 to one or more USB charger ports 414. An onboard USB auto-detector (not shown) is included to automatically detect the insertion of one or more USB cables into the USB charger ports 414. The adapter circuitry 318 provides 3 amps or greater of output power, providing rapid charging at the output side of the charge circuit board 318. The 3-5V output power supply at the USB charge ports 414 may be suitable to power and quickly recharge one or more electronic devices. An electrostatic-discharge (ESD) protection circuit 416 may be coupled to the one or more USB charger ports 414 to protect the charge circuit board 318 from static discharge generated by externally charged bodies.

In yet another embodiment, the multi-port input/output connector 404 may be configured as a dual purpose connector that functions both as an input connector for receiving power to charge the battery and output connector for supplying power to charge or power externally connected devices. When the multi-port input/output connector 404 is configured as an input connector, an external charger can be connected to a multi-pin port connector 418 to recharge the HVPT battery when the adapter is attached to the HVPT battery. When the multi-port input/output connector 404 is configured as an output connector, external extension modules can be connected to the multi-pin port connector 418 to supply various DC voltages and connector configurations used to power one or more electronic devices in addition to the USB output port 414. The external extension module may include a compact electronic circuitry and a connection interface which extends the circuitry of the adapter to provide various voltages, currents, and connector configurations other than the built-in USB output 414 on the adapter. Thus, in addition to the USB output port 414 supplying a power source connector to externally attached devices, the multi-port input/output connector 404 may be connected to an external output module (e.g., supplying a 14V 1A output), where the adapter can then supply the 14V 1A output at the multi-pin port connector 418 for charging externally attached batteries. In addition, an electrostatic-discharge (ESD) protection circuit 420 may be coupled to the multi-pin port 418 to protect the charge circuit board 318 from static discharge generated by externally charged bodies. In practice, this dual purpose functionality of the adapter and external modules can significantly reduce the component and cost of the adapter to the consumer market, while still providing a flexible way to power specialized electronic devices.

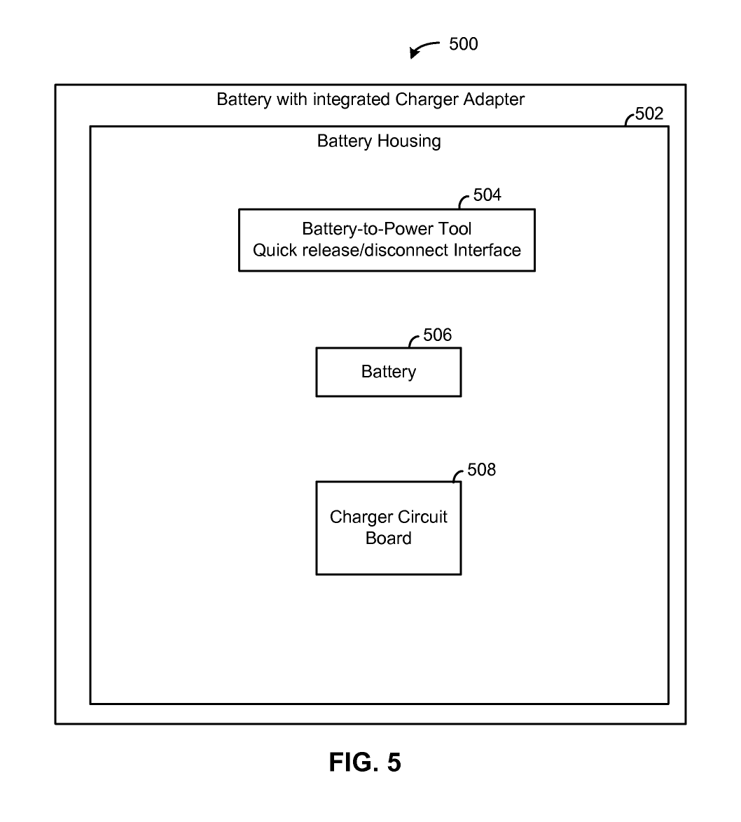

FIG. 5 illustrates a block diagram of mechanical and electrical components associated with another embodiment of a power tool adapter and charger 500. A battery 506 and a charge circuit board 508 may be fully integrated into a single battery enclosure 502, forming a battery with an integrated charger-adapter that operates directly on a power tool device. The battery housing 502 may also include a quick connect/disconnect interface mechanism 504 to mount the battery housing 502 to the power tool device. This configuration allows a power tool owner to simultaneously use the power tool device while supplying the necessary voltages to low voltage electronic devices via a USB cable (not shown).

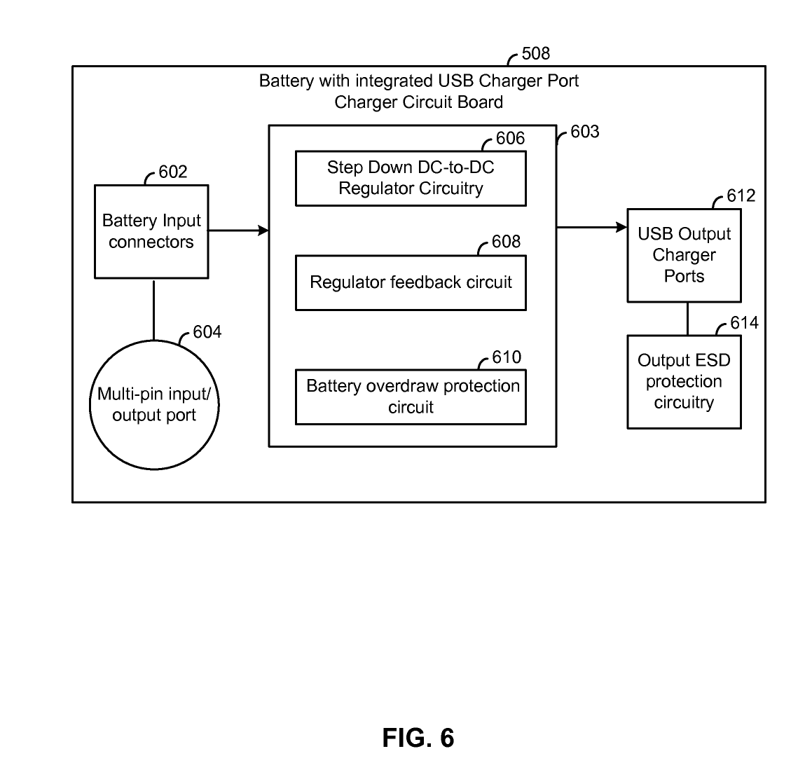

FIG. 6 illustrates a block diagram of mechanical and electrical components of the charger circuit board 508 of the battery with built-in charger adapter 500 depicted in FIG. 5. Power from a rechargeable battery source is supplied at battery input connectors 602 of the charge circuit board 508. A multi-pin input/output connector port 604 may be mounted on the charge circuit board 508 of the battery with built-in charger adapter 500 to receive multiple voltage inputs from a battery charger supply. The multi-pin input/output connector port 604 may include, but is not limited to, a pin or socket interconnection which may be keyed to ensure correct polarity connections between a cable connector of the battery and the charge circuit board 508. In operation, the multi-pin input/output connector port 604 may be suitable for supplying power having an output voltage between 3-28V to support one or more externally connected electronic devices.

A charge and adapter circuitry 603 disposed on the charge circuit board 508 includes a step down DC-to-DC converter/regulator circuit 606, a regulator feedback circuit 608 and a battery protection circuit 610. The battery overdraw protection circuitry 610 is included to prevent damage to charge circuit board 508, battery, and other electrical components by limit output current to less than 15 Amps in the event of a short-circuit, overdraw, or improper input voltage.

The step down DC-to-DC converter/regulator circuit 608 is responsible for converting and regulating the power supplied by the high DC voltage (14-48V) to a DC output voltage of 3V to 28V having a current of 3 Amps or greater.

The regulator feedback circuit 608 controls and maintains the output voltage at a constant voltage level (e.g., 3V to 28V).

A reduced regulated voltage of 3-5V is supplied at an output side of the charge circuit board 508 to one or more USB charger ports 612. An onboard USB auto-detector (not shown) is also included to automatically detect the insertion of one or more USB cables into the USB charger ports 612. The adapter circuitry 508 may also provide 3 amps or greater of output power, providing rapid charging at the output side of the charge circuit board 508. The 3-5V output power supply at the USB charge ports 612 may be suitable to power and quickly recharge one or more electronic devices.

Optionally, an electrostatic-discharge (ESD) protection circuit 614 at the output side of the charge circuit board 508 may be coupled to the one or more USB charger ports 612 as to protect the charge circuit board 508 from static discharge generated by externally charged bodies.

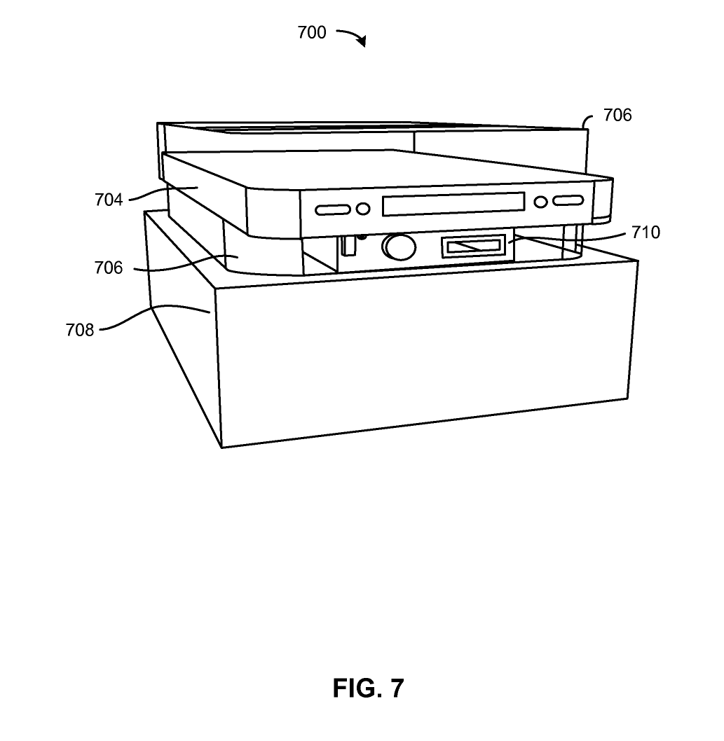

FIG. 7 illustrates a perspective view of interfacing components of a power tool rechargeable system 700 for a particular battery configuration including a cut-out view of an adapter enclosure 706, a power tool adapter and charger device 710, a power tool rechargeable battery 708, and a mobile phone 704. In FIG. 7, the adapter enclosure 706 includes a first device slot fitted to hold and secure the mobile phone 704, a second slot fitted to hold and secure the power tool adapter and charger device 710, and mounting mechanisms for securing the adapter enclosure 706 to the battery 708.

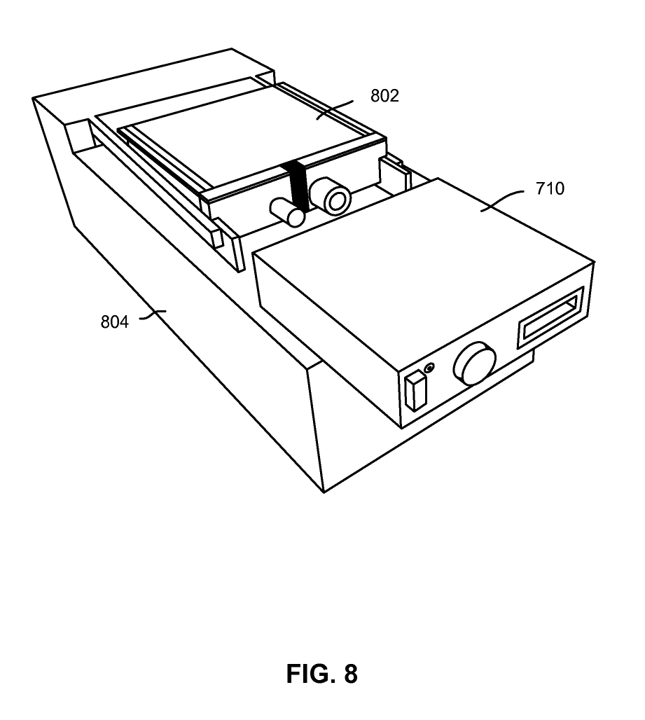

FIG. 8 illustrates a perspective view of interfacing components of the power tool rechargeable system 700 of FIG. 7 revealing a battery plate 802 for interconnecting the power tool adapter and charger device 710 to the battery 804.

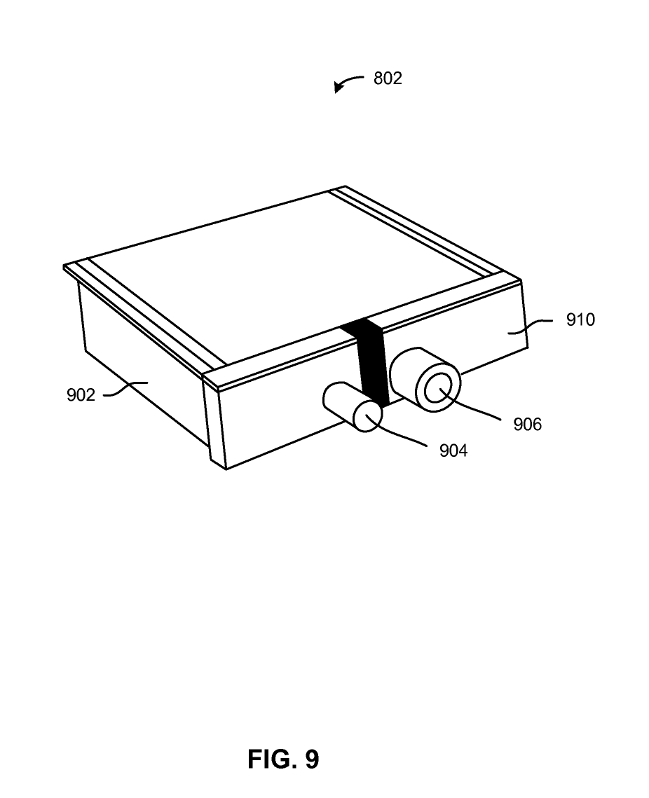

FIG. 9 illustrates components of the battery plate 802 depicted in FIG. 8. A positive (+) battery contact blade 902 is disposed below a first end of the battery plate 802, making contact to a positive terminal of the battery 708. A negative (−) battery contact blade (although not shown in detail) is formed below a second end of the battery plate 802, making electrical connection to the negative terminal of the battery 708. A positive DC terminal (+) 904 and a negative DC terminal (−) 906 are disposed on a front facing insulator plate 910 of the battery plate 802, forming an electrical connection to the positive (+) battery contact blade 902 and negative (−) battery contact blade, respectively. Each DC terminal may be keyed (e.g., male connector, female connector) to ensure correct polarity connections between the battery plate 802 and the power tool adapter and charger device 710. The insulator 910 plate electrically isolates and separates the positive DC terminal (+) 904 from the negative DC terminal (−) 906, preventing any possibility of shorting between the two terminals.

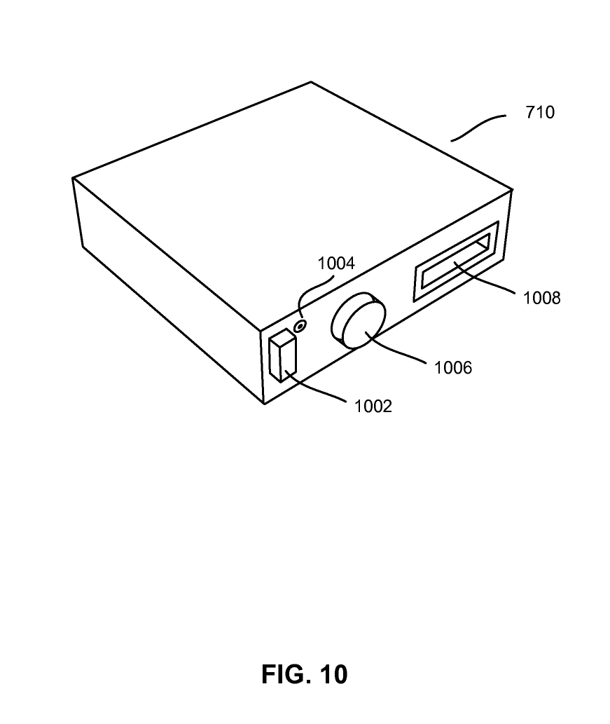

FIG. 10 illustrates components of a front panel of the power tool adapter and charger device 710 depicted in FIG. 7. The front panel of the power tool adapter and charger device 710 includes a power switch 1002 for enabling or disabling the power tool adapter and charger device 710, a LED indicator 1004 for providing ON/OFF status of the charger device 710, a selector switch 1006 for selecting various output voltages, and a USB output port 1008 for providing power to low power electronic devices via a USB cable (not shown).

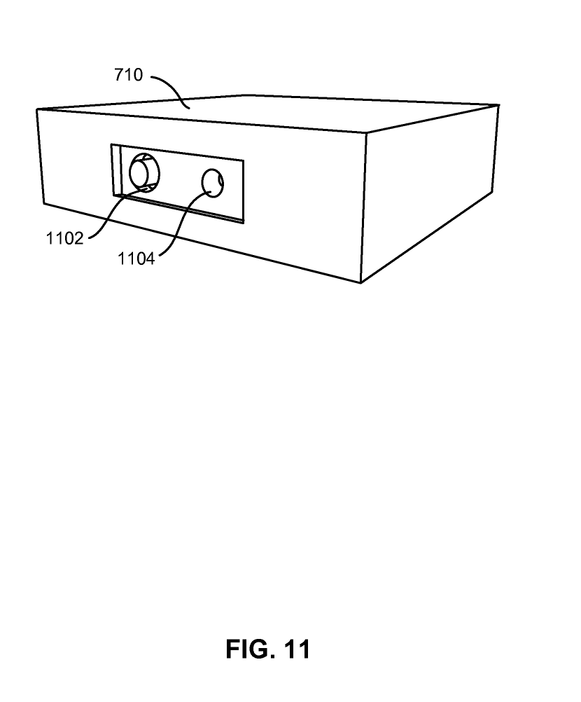

FIG. 11 illustrates components of a rear panel of the power tool adapter and charger device 710 depicted in FIG. 7. A negative (−) DC input terminal 1102 and a positive (+) DC input terminal 1104 are disposed on the rear panel of the power tool adapter and charger device 710 and are keyed to fit and complement the negative DC terminal (−) 906 and positive DC terminal (+) 904, respectively.

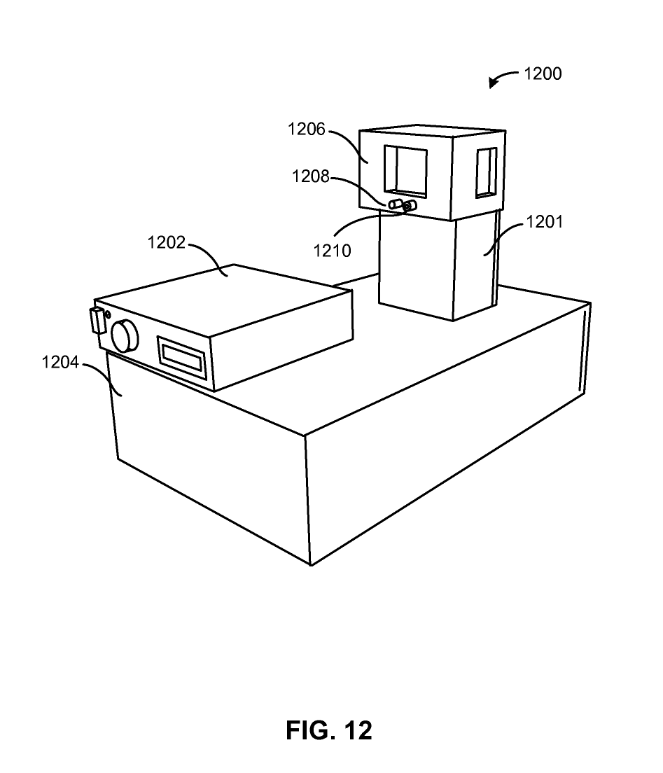

FIG. 12 illustrates a perspective view of a tower battery configuration 1200 connected to a power tool adapter 1202 and charger device. In one embodiment, a battery 1204 includes a vertical bar 1201 protruding from a first end of the battery 1204. The protruding end of the vertical bar 1201 is coupled to a battery cap 1206. A positive DC terminal (+) 1208 and a negative DC terminal (−) 1206 are fabricated on the battery cap 1206, forming a conductive path to the positive (+) battery and negative (−) terminals to the battery 1204, respectively. As in the previous example, each DC terminal may be keyed (e.g., male connector, female connector) to ensure correct polarity connections between the battery cap 1206 and the power tool adapter and charger device 1202.

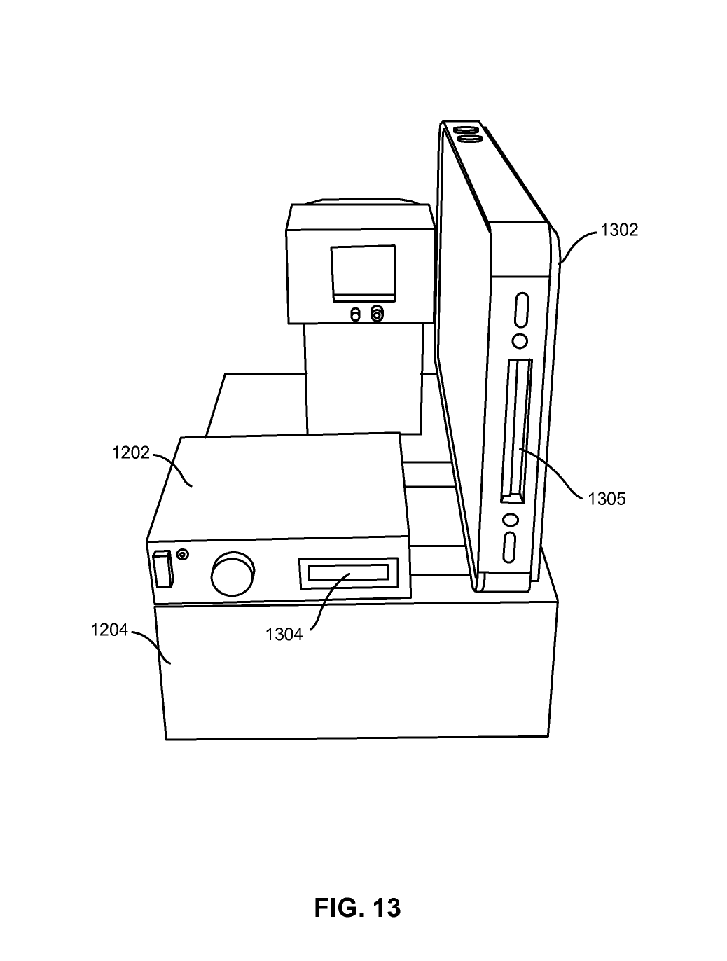

FIG. 13 illustrates a mobile phone 1302 vertically oriented and coupled to the tower battery configuration 1200. In operation, power is delivered from the battery 1204 to the power tool adapter and charger device 1202 of FIG. 12 via interconnecting cables (not shown). The input voltage to the power tool adapter and charger device 1202 is then converted to a 3-5V low voltage output at a USB port 1304 by the charger device 1202. Powering or recharging the mobile phone 1302 can be accomplished by connecting a USB cable adapter (not shown) from an input socket 1305 of the mobile phone 1302 to the USB port 1304.

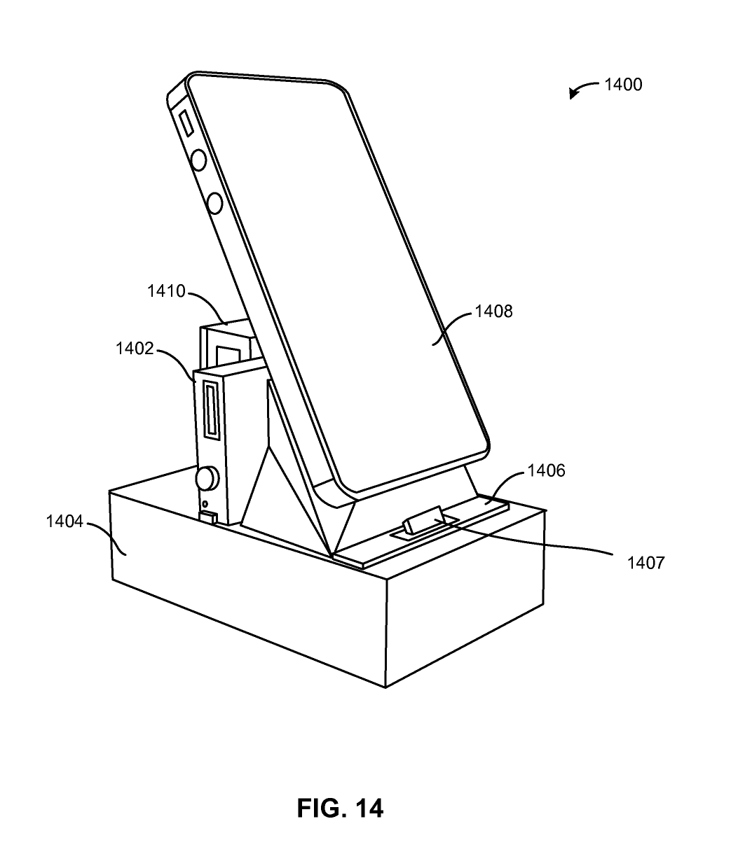

FIG. 14 illustrates a cradle-to-battery configuration 1400 including: a power tool adapter and charger 1402 device, a rechargeable battery 1404, a mobile phone 1408, and battery plate 1410. In this embodiment, the cradle 1406, which may also be known as a docking station, is disposed on the battery 1404 where power is supplied from the battery 1404 to a battery plate 1410 via a interconnecting hardware (not shown) which is electrically coupled to the charger 1402 device via an interconnecting cable (not shown) where power is converted to a low voltage (e.g., 3-7V) and fed to the mobile phone 1408 at an output socket 1407 disposed on the cradle 1406.

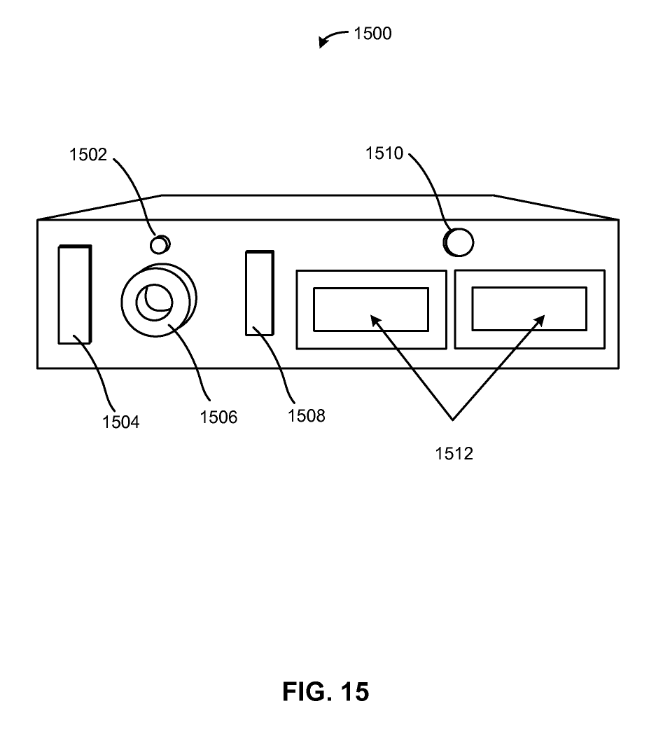

FIG. 15 illustrates components of a power tool adapter and charger device 1500 with multiple USB ports 1512 disposed on a front panel of the charge device 1500. In this embodiment, the multiple USB ports 1512 include two additional ports, each port when connected to a battery, produces an output of approximately 3-5V. Other components disposed on the front panel of the charge device 1500 include an ON/OFF Power switch 1504 for enable/disabling the charge device 1500, a dedicated 12V output socket connector 1506 applicable to common 12V appliances and mobile devices, a first LED indicator 1502 for displaying a light status (e.g., RED=Error/Low Battery, YELLOW=warning/error, Green=In Use/Active) of the 12V output socket connector 1506 when in use, a selector switch 1508 for selecting between the 12V output socket 1506 and the USB ports 1512, and a second LED indicator 1510 for displaying a light status (e.g., RED=Error/Low Battery, YELLOW=warning/error, Green=In Use/Active) of the 3-5V USB output ports 1512 when in use.

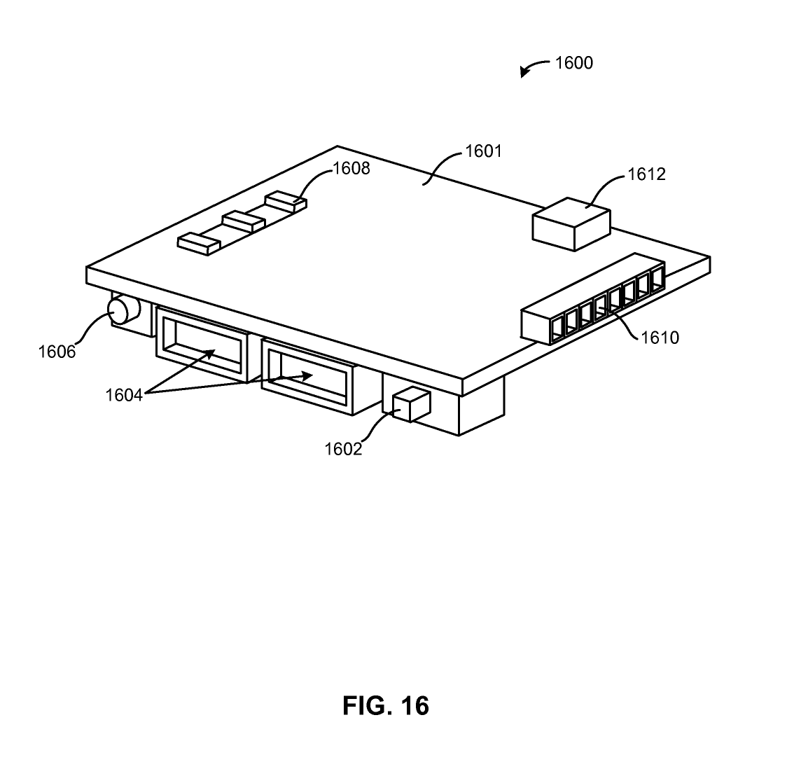

FIG. 16 illustrates a top perspective view of a printed circuit board 1601 of a power tool adapter and charger 1600. In this embodiment, a power ON/OFF switch 1602 is disposed on a first end of the printed circuit board 1601. A pair of USB output ports 1604 is also disposed on the first end of the printed circuit board 1601 and adjacent to the power switch 1602. A battery capacity check button 1606 for monitoring the battery charge level when depressed is disposed on the first end of the printed circuit board 1601 and adjacent to the pair of USB output ports 1604. Multiple LED indicator lights 1606 are disposed near a second end of the printed circuit board 1601, providing multiple status information related to the battery (not shown) and charger 1600. A battery connector port 1612 for electrically connecting the battery to the printed circuit board 1601 may be disposed on a third end of the printed circuit board 1601. A multi-pin input/output port 1610 for receiving and/or supplying multiple voltages may be disposed on a fourth end of the printed circuit board 1601. The multi-pin input/output port 1610 may include a multi-port connector for various input/output voltage configurations. The multi-port connector allows multiple portable electronic devices to connect and charge in parallel for quick recharge. In one configuration, the multi-port connector of the charger port 1610 may include a high voltage input to charge the battery of one or more portable electronic device. In another configuration, the multi-port connector of the charger port 1610 may include a low voltage output to power and charge multiple electronic devices connected in parallel. In yet another configuration, the multi-port connector of the charger port 1610 may include different low voltage outputs to power and charge multiple electronic devices in parallel, where each device has varying voltage requirements.

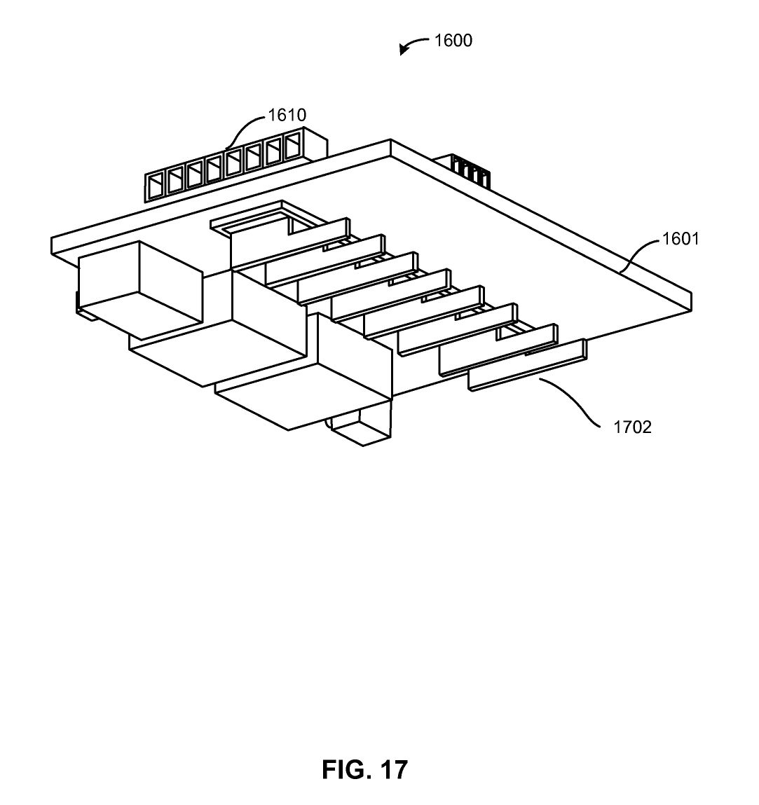

FIG. 17 illustrates a bottom perspective view of the circuit board 1601 of FIG. 16. Multiple conductive leads (or pins) 1702 are disposed on an opposing side of the circuit board 1601. One of each conductive lead is electrically connected to a corresponding port in the multi-port connector of the charger port 1610. The other end of each conductive lead is electrically connected to a corresponding voltage input/output source (not shown) via a cable connector (also not shown).

As used in the specification and the appended claims, the singular forms “a”, “an”, and “the” included plural referents unless the context clearly dictates otherwise.

All patents, patent applications, and other references cited herein are incorporated by reference in their entireties.

It is noted that the foregoing disclosure has been provided merely for the purpose of explanation and is in no way to be construed as limiting of the present invention. Although the present invention has been shown and described with respect to several preferred embodiments thereof, various changes, omissions, and additions to the form and detail thereof, may be made therein, without departing from the spirit and scope of the invention. It is understood that the words which have been used herein are words of description and illustration, rather than words of limitation. Changes may be made, within the purview of the appended claims, as presently stated and as amended, without departing from the scope and spirit of the present invention in its aspects.

Other embodiments and modifications of the present invention may occur to those of ordinary skill in the art in view of these teachings. Accordingly, the invention is to be limited only by the following claims which include all other such embodiments and modifications when viewed in conjunction with the above specifications and accompanying drawings.

What is claimed is:

1. A portable power tool adapter and charger device comprising:
an adapter enclosure;
a mechanical fitting disposed on an outer surface of the adapter enclosure, wherein the mechanical fitting facilitates engaging and disengaging the adapter and charger device to an external battery;
a charger circuitry contained within and attached to the adapter enclosure, wherein the charger circuitry comprises a step down DC-to-DC converter and a regulator feedback circuit, wherein the step down DC to DC converter converts an input voltage supplied by the external battery to a predetermined voltage; and
a plurality of USB output ports disposed on the charger circuitry, wherein an output voltage defined by the predetermined voltage is supplied at each USB output port.

2. The power tool adapter and charger device as in claim 1 wherein the external battery has a voltage between 14 and 48 volts.

3. The power tool adapter and charger device as in claim 1, wherein the predetermined voltage has a voltage output of about 3V to 28V.

4. The power tool adapter and the charger device as in claim 1, wherein the regulator feedback circuit is coupled to the step down DC-to-DC converter and regulator circuit, wherein the regulator feedback circuit controls and maintains the voltage output at a constant voltage level.

5. The power tool adapter and charger device as in claim 1, wherein the charger circuitry further comprises a protection circuit, wherein the protection circuit limits the amount of output current flow from the battery to less than 15 Amps.

6. The power tool adapter and charger device as in claim 1, wherein the charger circuitry further comprises a battery monitor circuit.

7. The power tool adapter and charger device as in claim 1, wherein the charger circuitry further comprises a plurality of battery input connectors.

8. The power tool adapter and charger device as in claim 1, wherein the charger circuitry further comprises a multi-pin input/output port.

9. The power tool adapter and charger device as in claim 1, wherein the charger circuitry further comprises an ESD protection circuit coupled to the USB output ports.

10. The power tool adapter and charger device as in claim 1, further comprises a plurality of heat vents defined by a plurality of slots formed in the adapter enclosure.

11. The power tool adapter and charger device as in claim 1, further comprises an LED window defined by an opening formed in the adapter enclosure.

12. The power tool adapter and charger device as in claim 1, further comprises a docking station disposed on the external battery.

13. An integrated power tool battery and charger device comprising:
a battery enclosure;
a mechanical fitting disposed on an outer surface of the battery enclosure, wherein the mechanical fitting facilitates engaging and disengaging to a power tool device;
an internal battery disposed within the battery enclosure;
a charger circuitry contained within and attached to the battery enclosure, wherein the charger circuitry comprises a step down DC-to-DC converter and a regulator circuit to convert an input voltage supplied by the internal battery to a predetermined voltage; and
a plurality of USB output ports disposed on the charger circuitry, wherein an output voltage defined by the predetermined voltage is supplied at each USB output port.

14. The integrated power tool battery and charger device as in claim 12 wherein the internal battery has a voltage between 14 and 48 volts.

15. The integrated power tool battery and charger device as in claim 12, wherein the predetermined voltage has a voltage output of 3V to 28V.

16. The integrated power tool battery and charger device as in claim 12, wherein the charger circuitry further comprises a regulator feedback circuit coupled to the step down DC-to-DC converter and regulator circuit, wherein the regulator feedback circuit controls and maintains the voltage output at a constant voltage level.

17. The integrated power tool battery and charger device as in claim 12, wherein the charger circuitry further comprises a plurality of battery input connectors.

18. The integrated power tool battery and charger device as in claim 12, wherein the charger circuitry further comprises a multi-pin input/output port.

19. The integrated power tool battery and charger device as in claim 12, wherein the charger circuitry further comprises an ESD protection circuit coupled to the USB output ports.
